(19) United States
(12) Patent Application Publication
(10) Pub. No.: US 2008/0080463 A1
(43) Pub. Date: Apr. 3, 2008

(54) Synchronization for a wireless communication device using multiple synchronization channels

(76) Inventors: Kenneth A. Stewart, Grayslake, IL (US); Brian K. Classon, Palatine, IL (US); Ravi Kuchibhotla, Gurnee, IL (US); Robert T. Love, Barrington, IL (US); Kevin Baum, Rolling Meadows, IL (US)

Correspondence Address: MOTOROLA INC, 600 NORTH US HIGHWAY 45, W4 - 39Q, LIBERTYVILLE, IL, 60048-5343, US

(21) Appl. No.: 11/542,287

(22) Filed: Oct. 2, 2006

(51) Int. Cl. H04B 7/216

(52) U.S. Cl. 370/342

(57) ABSTRACT

A method (400, 500) and apparatus for synchronization for a wireless communication device (300) using multiple synchronization channels. An initial cell search can be performed (420) by the wireless communication device (300). During the initial cell search, a primary synchronization symbol can be acquired (430) only on a center synchronization channel of a plurality of synchronization channels. The plurality of synchronization channels can include the center synchronization channel and a plurality of secondary synchronization channels. The primary synchronization symbol can be associated with the plurality of secondary synchronization channels. A frequency translation can be executed (460) to change a receive channel to acquire one of the secondary synchronization channels.

### BACKGROUND

1. Field

The present disclosure is directed to a method and apparatus for synchronization for a wireless communication device using multiple synchronization channels. More particularly, the present disclosure is directed to providing multiple synchronization channels to allow for operation of wireless communication devices with low bandwidth.

2. Description of Related Art

Presently, technology continues to evolve for wireless devices, such as cellular phones, to allow for a richer user experience. Wireless devices are also tiered according to cost and power consumption. For example, higher bandwidth systems and wireless devices are being designed that allow for faster and better quality data transfer. It is useful for these systems to allow both newer wireless devices and older wireless devices, or devices with greater or lesser capability, to operate in a coherent fashion. For example, a large segment of users may already have an older wireless device and may be unwilling to instantly discard the older wireless device every time a new system is implemented.

In operation, for example, when a user powers up a wireless device, the wireless device performs an initial cell search and looks for a carrier frequency to access, and more specifically for a synchronization channel. A synchronization channel design is being currently considered to permit older or lower capability wireless devices that have a limited minimum bandwidth capability, such as 10 MHz, to access alternative or newer broader-band channels, such as 20 MHz channels. Other combinations are possible, such as 10 MHz devices operating in 15 MHz channels, and the like. The bandwidth of each synchronization channel waveform can be 1.25 MHz, or some other value. However, the precise structure of each synchronization channel waveform is yet to be determined. In such a scenario, three synchronization channel waveforms need not be, but may be transmitted simultaneously, or at least at some specified stagger in time. The center synchronization channel in the 20 MHz bandwidth can be used for initial cell search by all wireless devices. The center synchronization channel can also be used for neighbor cell measurements by 20 MHz wireless devices. The synchronization channels in the center of a upper and lower 10 MHz band may be used for neighbor cell search for 10 MHz capability wireless devices.

Unfortunately, this structure creates a number of problems for which solutions are required. For example, there is an incongruity between the standard 200 kHz carrier raster adopted by the 3^{rd} Generation Partnership Project (3GPP) and the 15 kHz sub-carrier separation adopted as the core sub-carrier raster for Long Term Evolution systems. The lowest common frequency multiple can require separation of the center, upper, and lower synchronization channels by 600 kHz intervals. This can lead to, for example, 9.6 MHz or 10.2 MHz separations which may not be well-suited to efficient deployment practices. Also, a wireless device observing a single synchronization channel on the carrier raster during initial cell search would not be aware of whether the detected synchronization channel symbol is associated with a lower or upper 10 MHz carrier channel or with the center of the 20 MHz carrier.

Furthermore, present systems do not provide an adequate means for initially synchronizing wireless devices with a network when the wireless devices have different bandwidth capabilities during an initial cell search, for example, when a wireless device wakes up. Furthermore, present systems do not provide for signals for other cell measurements to optimize handover decisions in the context of variable bandwidth operation.

Thus, there is a need for a method and apparatus for synchronization for a wireless communication device using multiple synchronization channels.

### SUMMARY

A method and apparatus for synchronization for a wireless communication device using multiple synchronization channels. An initial cell search can be performed by the wireless communication device. During the initial cell search, a primary synchronization symbol can be acquired only on a center synchronization channel of a plurality of synchronization channels. The plurality of synchronization channels can include the center synchronization channel and a plurality of secondary synchronization channels. The primary synchronization symbol can be associated with the plurality of secondary synchronization channels. A frequency translation can be executed to change a receive channel to acquire one of the secondary synchronization channels.

### BRIEF DESCRIPTION OF THE DRAWINGS

The embodiments of the present disclosure will be described with reference to the following figures, wherein like numerals designate like elements, and wherein:

FIG. 1 is an exemplary block diagram of a system according to one embodiment;

FIG. 2 is an exemplary illustration of a plurality of synchronization channels according to one embodiment;

FIG. 3 is an exemplary block diagram of a wireless communication device according to one embodiment;

FIG. 4 is an exemplary flowchart illustrating the operation of a wireless communication device according to one embodiment;

FIG. 5 is an exemplary flowchart illustrating the operation of a system according to another embodiment; and

FIG. 6 is an exemplary flowchart illustrating the operation of the wireless communication device according to another embodiment.

### DETAILED DESCRIPTION

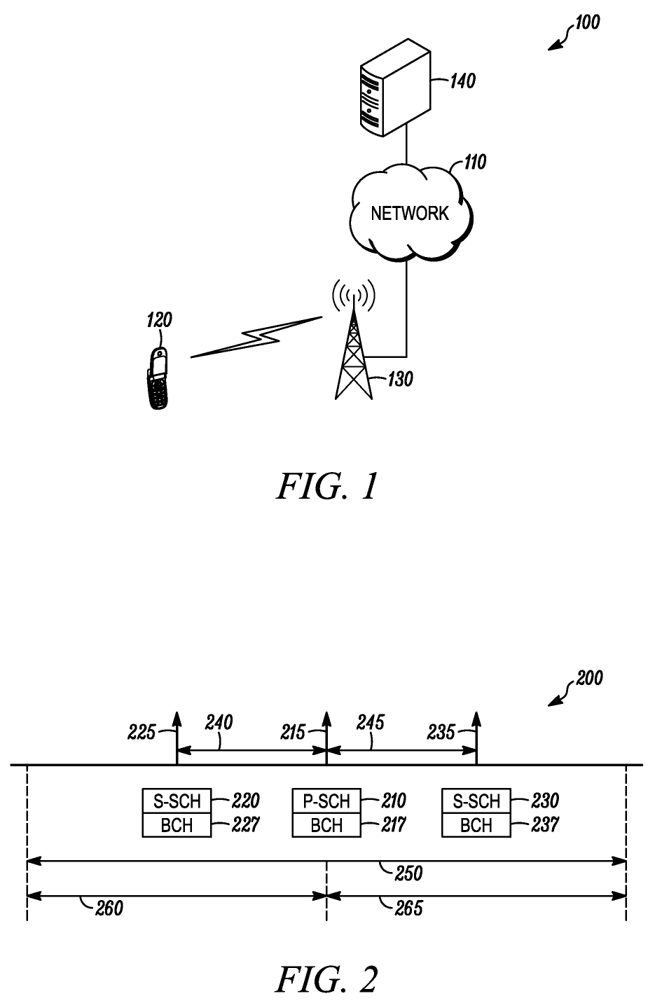

FIG. 1 is an exemplary block diagram of a system 100 according to one embodiment. The system 100 can include a network controller 140, a network 110, a base station 130 and a terminal 120. The terminal 120 may be a wireless communication device, such as a wireless telephone, a cellular telephone, a personal digital assistant, a pager, a personal computer, a selective call receiver, or any other device that is capable of sending and receiving communication signals on a network including wireless network.

In an exemplary embodiment, the network controller 140 is connected to the network 110. The controller 140 may be located at the base station 130, at a radio network controller, or anywhere else on the network 110. The network 110 may include any type of network that is capable of sending and receiving signals, such as wireless signals. For example, the network 110 may include a wireless telecommunications network, a cellular telephone network, a Time Division Multiple Access (TDMA) network, a Code Division Multiple Access (CDMA) network, a satellite communications network, and other like communications systems. Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving communication signals.

FIG. 2 is an exemplary illustration 200 of a plurality of synchronization channels 210, 220, and 230 associated with frequencies 215, 225, and 235 respectively used on the network 100 according to one embodiment. A primary synchronization symbol can be transmitted on a center synchronization channel 210. Secondary synchronization symbols can be transmitted on secondary synchronization channels 220 and 230. Messages can also be transmitted on broadcast channels 217, 227, and 237, where it should be noted that the broadcast channels 217, 227, and 237 need not all be identically configured, e.g. need not all support the same information rate, or be constructed using the same modulation and encoding means. The secondary synchronization channels 220 and 230 can be offset from the center synchronization channel 210 by an offset frequency 240 and 245. The synchronization channels 210, 220, and 230 can be used for terminals operating at a first maximum bandwidth 250, or at a second maximum bandwidth 260 and 265 that is less than the first maximum bandwidth.

In operation, a terminal 120 can perform an initial cell search. During the initial cell search, the terminal 120 can acquire a primary synchronization symbol only on a center synchronization channel 210 of a plurality of synchronization channels 210, 220, and 230. The plurality of synchronization channels can include the center synchronization channel 210 and a plurality of secondary synchronization channels 220 and 230. The primary synchronization symbol can be associated with the plurality of secondary synchronization channels 220 and 230. The terminal 120 can execute a frequency translation to change a receive channel to acquire one of the secondary synchronization channels 220 or 230. The secondary synchronization channels 220 and 230 may occur at the same time or at a later time as the center synchronization channel 210. A lower bandwidth terminal may make and optionally report measurements of a secondary synchronization channel symbol in co-frequency secondary synchronization channels. Additionally, adjacent secondary synchronization channel indices and/or associated cell identifiers may be different from a center synchronization channel cell identifier.

In a complementary operation, the controller 140 can transmit a primary synchronization symbol only on a center synchronization channel 210 of the plurality of synchronization channels 210, 220, and 230. The plurality of synchronization channels can include the center synchronization channel 210 and a plurality of secondary synchronization channels 220 and 230. The primary synchronization symbol can be associated with the plurality of secondary synchronization channels 220 and 230. The controller 140 can also transmit synchronization symbols on the plurality of secondary synchronization channels 220 and 230. Each of the plurality of secondary synchronization channels 220 and 230 can be located at a specified offset frequency 240 and 245 from the center synchronization channel 210.

Thus, in a scenario using both 20 MHz and 10 MHz bandwidth terminals, the system 100 can deliver system information via a broadcast channel where only the center synchronization channel 210 includes a valid primary synchronization symbol. The primary synchronization symbol can be associated with a secondary synchronization channel 220. The center primary synchronization symbol, the secondary synchronization symbol, and an associated 20 MHz carrier, can be located on a conventional 3^{rd} Generation Partnership Project 200 kHz carrier raster frequency. Typically, lower and upper 10 MHz channels 220 and 230 do not transmit a primary synchronization symbol, which can prevent any possibility of a terminal attempting to camp on either secondary 10 MHz channel during an initial cell search. Rather, a terminal 120 can identify the center primary synchronization channel 210 during the initial search and can read a system information message on the associated broadcast channel 217 that identifies the center synchronization channel 210 as associated with a 20 MHz carrier. Other ways to prevent or minimize the chance of a terminal camping on a secondary channel include having the secondary synchronization channels have a different format, not be present at the same time, or not be on the same 200 kHz raster, as the primary synchronization channel. An example of a different format is that the primary synchronization channel may be on every second subcarrier within the primary synchronization channel bandwidth to create time domain symmetry, and to every subcarrier within the secondary synchronization channel bandwidth so there is no waveform symmetry and different correlation results. In an alternate embodiment, the identification of the center primary synchronization channel 210 as associated with a 20 MHz carrier, or other system information, may also be accomplished by having the center primary synchronization channel 210 have alternate format where the terminal 120 attempts to detect each possible format, and the format type conveys system information. For example, the structure of an OFDM symbol associated with the primary synchronization channel 210 may be dependent on the system information. In more detail, an OFDM symbol associated with the primary synchronization channel may be populated with sub-carrier data symbols whose symbol values vary with the system information. Or, similarly, an OFDM symbol associated with the primary synchronization channel 210 may be selected from a population of possible OFDM symbols each of which forms a valid primary synchronization channel, where the selected symbol index conveys the system information. Or the quadrature phase of the primary synchronization channel may be adjusted with respect to one or more of the associated secondary synchronization channels, and so on. In this way, the necessary system information may be conveyed, and broadcast over the coverage area of the cell, without constructing a conventionally modulated data stream. For the present purpose, however, any such means of conveying system information is referred to as a broadcast channel or BCH.

The primary and secondary synchronization channels can take a variety of forms. For example, the primary synchronization channel may comprise part or all of one or more Orthogonal Frequency Division Multiplexed (OFDM) symbols with a specific structure, such as a particular repetition pattern or sequence. The secondary synchronization channel may comprise part or all of one of more OFDM symbols with a specific structure, such as a particular repetition pattern or sequence, and may have a different structure that then primary synchronization channel. The secondary synchronization channels may be embedded as a set of known reference symbol values interspersed with data symbols. The primary and secondary synchronization channels may each comprise multiple parts. For example, the primary channel may comprise a first portion of certain subcarriers on an OFDM symbol and a second part of embedded reference symbol values interspersed with control or data symbols.

A 20 MHz bandwidth terminal can monitor both upper and lower 10 MHz segments, and read one or both of the broadcast channels 227 and 237 configured on the respective upper and lower 10 MHz channels 220 and 230. A 10 MHz bandwidth terminal can frequency translate by a specified frequency offset, such as offset 240 or 245, in the lower or upper frequency direction. The direction can be based on a random or fixed assignment, according to static or semi-static rules using an identifier of the terminal, such as an International Mobile Subscriber Identity, or based on other useful information. The direction may also be selected based on current system load of the respective upper and lower 10 MHz channels 220 and 230, where 10 MHz terminals synchronizing to the system may be directed to, for example, the more lightly loaded of the upper and lower channels. Synchronization symbol provisioning on the lower and upper 10 MHz channels, such as channels 220 and 230, can use only a valid secondary synchronization symbol. Also, the sub-carrier set allocated to the lower and upper secondary synchronization channels 220 and 230, and therefore the location of the lower and upper channels in frequency and in the overall 20 MHz sub-carrier grid, can be specified by a center broadcast system information message or other signalling indication on the center broadcast channel 217. The center broadcast system information message can specify, for example, in units of sub-carrier separation or multiple thereof and possibly over a pre-specified range, the desired frequency offset of the 10 MHz channels 220 and 230 and associated secondary synchronization symbols.

Accordingly, for example, the system 100 can provide for delivery of a primary synchronization symbol in association with a subset or only one of a multiplicity of synchronization symbols separated in frequency but associated with a single parent carrier frequency or channel. The system 100 can also provide for alignment of only the primary synchronization channel-associated synchronization symbol with a carrier frequency raster according to a specified raster frequency set, and re-direction of lower-capability terminals using a frequency offset from the primary synchronization channel-associated synchronization channel symbol to a sub-channel in frequency of the carrier frequency. The system 100 can further provide for re-direction of lower-capability terminals to specific frequency channels according to one or more terminal-specific identifiers, including modifying the identification criteria in a dynamic fashion according to system load or other criteria. The system 100 can also provide for specification of the frequency offset applicable to re-direct terminals according to a frequency offset value delivered by the network 110, where the location in frequency of the frequency channel associated with the re-direction need not align with the carrier frequency raster. The system 100 can additionally provide for construction of a reduced capacity or primitive broadcast channel associated with a primary synchronization channel-associated synchronization channel symbol. The system 100 can further provide for selection and indication of one or more sub-channel specific broadcast channels to deliver information on a multi-channel carrier frequency to terminals with higher frequency channel capability.

Consequently, the system 100 can, for example, provide a means for initially synchronizing terminals that have different bandwidth capabilities with a cellular network during an initial cell search, for example when a terminal wakes up. Furthermore, the system 100 can provide for signals for other cell measurements to optimize handover decisions.

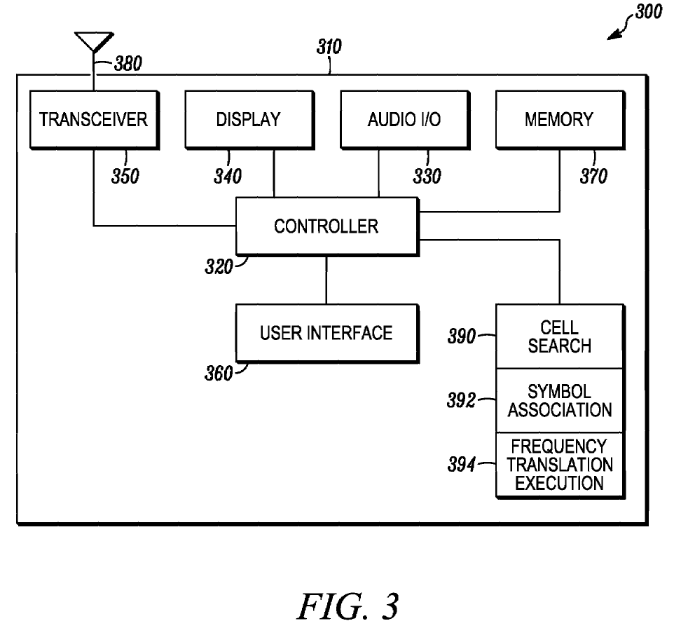

FIG. 3 is an exemplary block diagram of a wireless communication device 300, such as the terminal 120, according to one embodiment. The wireless communication device 300 can include a housing 310, a controller 320 coupled to the housing 310, audio input and output circuitry 330 coupled to the housing 310, a display 340 coupled to the housing 310, a transceiver 350 coupled to the housing 310, a user interface 360 coupled to the housing 310, a memory 370 coupled to the housing 310, and an antenna 380 coupled to the housing 310 and the transceiver 350. The transceiver 350 can include a local oscillator. The wireless communication device 300 can also include a cell search module 390, a symbol association module 392, and a frequency translation execution module 394. The cell search module 390, the symbol association module 392, and/or the frequency translation execution module 394 can be coupled to the controller 320, can reside within the controller 320, can reside within the memory 370, can be autonomous modules, can be software, can be hardware, or can be in any other format useful for a module on a wireless communication device 300.

The display 340 can be a liquid crystal display (LCD), a light emitting diode (LED) display, a plasma display, or any other means for displaying information. The transceiver 350 may include a transmitter and/or a receiver. The audio input and output circuitry 330 can include a microphone, a speaker, a transducer, or any other audio input and output circuitry. The user interface 360 can include a keypad, buttons, a touch pad, a joystick, an additional display, or any other device useful for providing an interface between a user and an electronic device. The memory 370 may include a random access memory, a read only memory, an optical memory, a subscriber identity module memory, or any other memory that can be coupled to a wireless communication device.

In operation, the controller 320 can be configured to control operations of the wireless communication device 300. The cell search module 390 can to perform an initial cell search. During the initial cell search, the cell search module 390 can acquire a primary synchronization symbol only on a center synchronization channel of a plurality of synchronization channels, where the plurality of synchronization channels can include the center synchronization channel and a plurality of secondary synchronization channels. The symbol association module 392 can associate the primary synchronization symbol with the plurality of secondary synchronization channels. The frequency translation execution module 394 can execute a frequency translation to change a receive channel to acquire one of the secondary synchronization channels. The frequency translation execution module 394 can also execute the frequency translation by adjusting the local oscillator reference frequency to change a receive channel to acquire one of the secondary synchronization channels. The frequency translation execution module 394 can also process information from a system information message or other indication on a broadcast channel centered on the center synchronization channel, the system information message or indication including parameters that identify an amount of frequency translation. The transceiver 350 can receive additional system information messages on at least one broadcast channel centered on at least one of the plurality of secondary synchronization channels, where the broadcast channels centered on at least one of the plurality of secondary synchronization channels may have higher information bearing capability than the broadcast channel or signalling indication centered on the center synchronization channel. The primary synchronization symbol can be located on a 200 kHz raster.

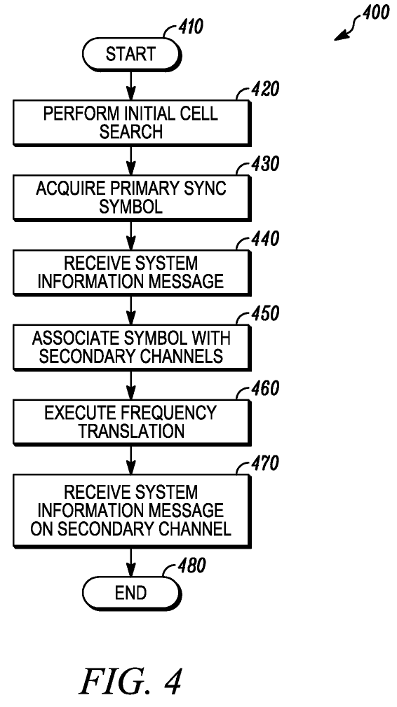

FIG. 4 is an exemplary flowchart 400 illustrating the operation of the wireless communication device 300 according to another embodiment. In step 410, the flowchart begins. In step 420, the wireless communication device 300 can perform an initial cell search. In step 430, the wireless communication device 300 can acquire, during the initial cell search, a primary synchronization symbol only on a center synchronization channel of a plurality of synchronization channels, where the plurality of synchronization channels can include the center synchronization channel and a plurality of secondary synchronization channels. The wireless communication device 300 can acquire the primary synchronization channel further by establishing a time and frequency synchronization with respect to the center primary synchronization symbol. The primary synchronization symbol may be located on a 200 kHz raster. Synchronization to secondary synchronization channels may be prevented by having the secondary synchronization channels have a different format, not be present at the same time, or not be on the same 200 kHz raster, as the primary synchronization channel. An example of a different format is that the primary synchronization channel may be on every second subcarrier within the primary synchronization channel bandwidth to create time domain symmetry, and to every subcarrier within the secondary synchronization channel bandwidth so there is no waveform symmetry and different correlation results. The plurality of secondary synchronization channels can include an upper secondary synchronization channel located at a specified offset frequency above the center synchronization channel and a lower secondary synchronization channel located at a specified offset frequency below the center synchronization channel.

In step 440, the wireless communication device 300 can receive a system information message or other signalling indication on a broadcast channel centered on the center synchronization channel, where a broadcast channel at least specifies a signalling channel transmitted over the coverage area of a cell. The system information message or indication can include parameters that identify an amount of frequency translation. Alternately, a system information message may not be necessary to identify an amount of frequency translation. For example, the amount of frequency translation may be a set amount. The amount of frequency translation or direction of frequency translation may also be determined by system information determined from the format of one or more parts of the center primary synchronization channel 210, where the terminal 120 detects the format, and the format type conveys the system information.

In step 450, the wireless communication device 300 can associate the primary synchronization symbol with the plurality of secondary synchronization channels. In step 460, the wireless communication device 300 can execute a frequency translation to change a receive channel to acquire one of the secondary synchronization channels. The wireless communication device 300 can execute the frequency translation by adjusting a local oscillator reference frequency to change a receive channel to acquire one of the secondary synchronization channels. The frequency translation can be a frequency offset magnitude and direction from the center synchronization channel. For example, the direction can be based on a on a static attribute or can be performed in a pseudo random manner. As a further example, the direction can be pseudo random by being based on a bottom bit in a subscriber identifier for the wireless communication device 300. The direction may also be based on a system load or based on service availability. As an example, a specific service, like a multimedia service may only be available at a certain frequency. Furthermore, executing a frequency translation can also include time translation. Also, the frequency translation can be specified in units of orthogonal frequency division multiple access sub-carrier separation. The frequency translation can be a set static frequency offset from the center synchronization channel.

In step 470, the wireless communication device 300 can receive additional system information messages on at least one broadcast channel centered on at least one of the plurality of secondary synchronization channels. In step 480, the flowchart 400 ends.

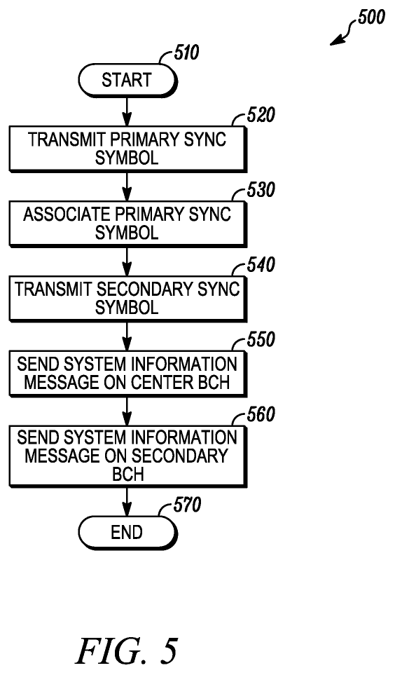

FIG. 5 is an exemplary flowchart 500 illustrating the operation of the system 100 according to another embodiment. In step 510, the flowchart begins. In step 520, the system 100 can transmit a primary synchronization symbol only on a center synchronization channel of a plurality of synchronization channels. The plurality of synchronization channels can include the center synchronization channel and a plurality of secondary synchronization channels. The plurality of secondary synchronization channels can include an upper secondary synchronization channel located at a specified offset frequency above the center synchronization channel and a lower secondary synchronization channel located at a specified offset frequency below the center synchronization channel. The primary synchronization symbol can be located on a 200 kHz raster.

In step 530, the system 100 can associate the primary synchronization symbol with the plurality of secondary synchronization channels. In step 540, the system 100 can transmit at least secondary synchronization symbols on a plurality of secondary synchronization channels. Each of the plurality of secondary synchronization channels can be located at a specified offset frequency from the center synchronization channel. The specified offset frequency can be a set static frequency offset from the center synchronization channel. The specified offset frequency can also include a frequency offset magnitude and direction from the center synchronization channel. The specified offset frequency can be specified in units of orthogonal frequency division multiple access sub-carrier separation.

In step 550, the system 100 can send a system information message on a broadcast channel centered on the center synchronization channel, the system information message including parameters that identify the specified offset frequency. In step 560, the system 100 can send additional system information messages on at least one broadcast channel centered on a secondary synchronization channel. In step 570, the flowchart 500 ends.

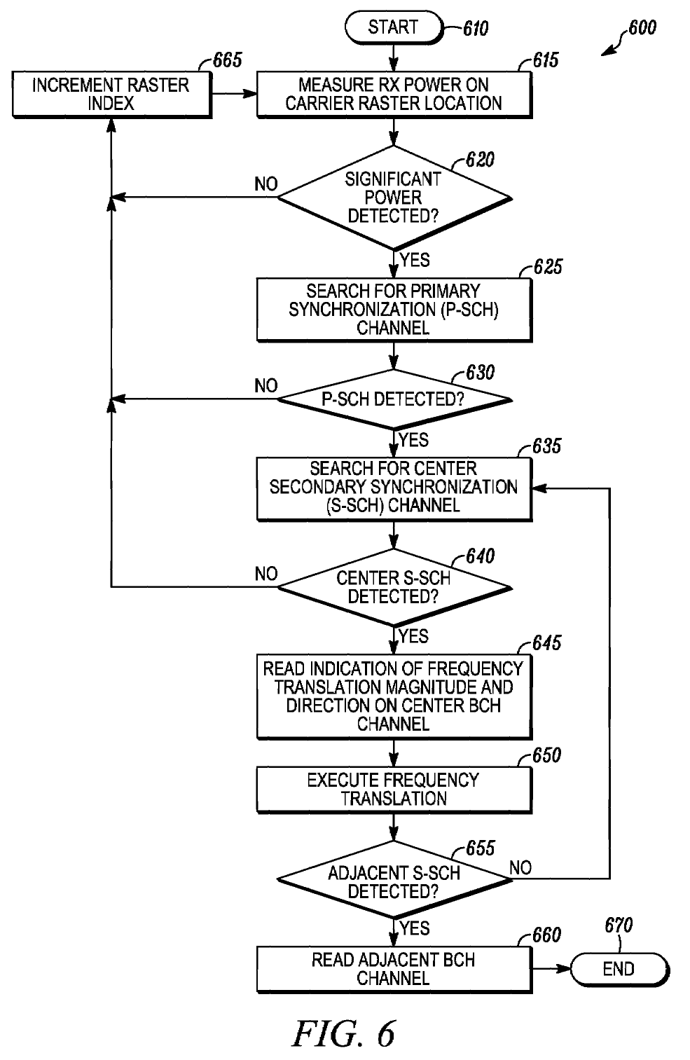

FIG. 6 is an exemplary flowchart 600 illustrating the operation of the wireless communication device 300 according to another related embodiment. The flowchart 600 can outline the operation of a 10 MHz wireless device in a 20 MHz carrier system. In step 610, the flowchart begins. In step 615, the wireless communication device 300 can optionally measure a received (‘Rx’) power level on a carrier raster location. If the wireless communication device 300 measures the receive power, in step 620, the wireless communication device 300 can determine if significant power is detected on the carrier raster. If significant power is detected, in step 625, the wireless communication device 300 can search for a primary synchronization channel. In step 630, the wireless communication device 300 can determine if a primary synchronization channel was detected. If a primary synchronization channel was detected, in step 635, the wireless communication device 300 can search for a center secondary synchronization channel. For example, in this embodiment, a secondary synchronization channel may be located at the center frequency, although as indicated in the embodiment of FIG. 2, an embodiment in which the secondary synchronization channel is not present at the center frequency is also possible. In step 640, the wireless communication device 300 can determine if the center secondary synchronization channel was detected.

If the center secondary synchronization channel was detected, in step 645, the wireless communication device 300 can read an indication of frequency translation magnitude and direction on a center broadcast channel. In step 650, the wireless communication device 200 can execute frequency translation.

In step 655, the wireless communication device 200 can determine if an adjacent secondary synchronization channel, such as channel 220 and 230, was detected. Thus, in this embodiment, secondary synchronization channels may be located both at the center frequency 215 and at adjacent frequencies, such as frequencies 225 and 235. If the adjacent secondary synchronization channel was detected, in step 660, the wireless communication device 200 can read the adjacent broadcast channel 660. If in step 655, the wireless communication device 200 did not detect the adjacent secondary synchronization channel, the flowchart 600 can return to step 635. If a negative result occurs in any of steps 620, 630, and 640, in step 665, the wireless communication device 200 can increment a raster index and continue with step 615. In each decision step in the flowchart 600, counters may be used to count the number of re-try's or timers may be used to count the time before moving on to a next step. Furthermore, different reversion strategies may be used in various steps of the channel acquisition process. In step 670 the flowchart 600 can end.

In yet another embodiment, the structure of FIG. 2 may be modified to permit the transmission of modified forms of the primary synchronization symbol on the secondary synchronization channels. Such modifications could include modification of the content or order of the sub-carriers comprising the OFDM symbol comprising the primary synchronization symbol transmitted on the center synchronization channel. Regardless of this, however, only the center synchronization channel may transport primary synchronization symbols from the set of synchronization symbols reserved for identifying the center of the wideband carrier frequency.

The method of this disclosure was described with examples of 10 MHz terminals and a 20 MHz system bandwidth. The terms “10 MHz” and “20 MHz” can be nominal and the actual transmission bandwidth may vary. For example, the bandwidth capability may be described in terms of the number of occupied subcarriers or groups of subcarriers. In addition, the methods may also apply for 15 MHz terminals on a 20 MHz system bandwidth, 10 MHz terminals on a 15 MHz band, or other terminals and systems using other bandwidths. The location of the plurality of secondary synchronization channels may not be in the center of 10 MHz portions of the 20 MHz band, or may not be in the center of the transmission or reception bandwidth of a terminal. For example, for 15 MHz terminals on a 20 MHz band, the terminals may be directed to one of the upper of lower bands, but the plurality of secondary synchronization channels may be located at the lower or upper ½ point of the 15 MHz bandwidth. For 10 MHz terminals on a 15 MHz band, all synchronization could occur in the center band as long as the primary synchronization bandwidth is approximately 5 MHz or less.

The method of this disclosure is preferably implemented on a programmed processor. However, the controllers, flowcharts, and modules may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

What is claimed is:

1. A method in a wireless communication device comprising:
performing an initial cell search;
acquiring, during the initial cell search, a primary synchronization symbol only on a center synchronization channel of a plurality of synchronization channels, the plurality of synchronization channels including the center synchronization channel and a plurality of secondary synchronization channels;
associating the primary synchronization symbol with the plurality of secondary synchronization channels; and
executing a frequency translation to change a receive channel to acquire one of the secondary synchronization channels.

2. The method according to claim 1, wherein executing the frequency translation comprises adjusting a local oscillator reference frequency to change a receive channel to acquire one of the secondary synchronization channels.

3. The method according to claim 1, wherein acquiring the primary synchronization symbol further comprises establishing a time and frequency synchronization with respect to the center synchronization symbol.

4. The method according to claim 1, wherein the frequency translation comprises a set static frequency offset from the center synchronization channel.

5. The method according to claim 1, wherein the frequency translation comprises a frequency offset magnitude and direction from the center synchronization channel.

6. The method according to claim 1, wherein the frequency translation is specified in units of orthogonal frequency division multiple access sub-carrier separation.

7. The method according to claim 1, further comprising
receiving a system information message on a broadcast channel centered on the center synchronization channel, the system information message including parameters that identify an amount of frequency translation.

8. The method according to claim 7, further comprising
receiving additional system information messages on at least one broadcast channel centered on at least one of the plurality of secondary synchronization channels.

9. The method according to claim 1, wherein the primary synchronization symbol is located on a 200 kHz raster.

10. The method according to claim 1, wherein the plurality of secondary synchronization channel comprise an upper secondary synchronization channels located at a specified offset frequency above the center synchronization channel and a lower secondary synchronization channel located at a specified offset frequency below the center synchronization channel.

11. The method according to claim 1, wherein the primary synchronization channel comprises at least one synchronization symbol, the at least one synchronization symbol comprising a reserved synchronization symbol reserved for identifying a center of a wideband carrier frequency.

12. A method in a wireless communication network comprising:
transmitting a primary synchronization symbol only on a center synchronization channel of a plurality of synchronization channels, the plurality of synchronization channels including the center synchronization channel and a plurality of secondary synchronization channels;
associating the primary synchronization symbol with the plurality of secondary synchronization channels; and
transmitting secondary synchronization symbols on the plurality of secondary synchronization channels, where each of the plurality of secondary synchronization channels is located at a specified offset frequency from the center synchronization channel.

13. The method according to claim 12, wherein the specified offset frequency comprises a set static frequency offset from the center synchronization channel.

14. The method according to claim 12, wherein the specified offset frequency comprises a frequency offset magnitude and direction from the center synchronization channel.

15. The method according to claim 12, wherein the specified offset frequency is specified in units of orthogonal frequency division multiple access sub-carrier separation.

16. The method according to claim 12, further comprising
sending a system information message on a broadcast channel centered on the center synchronization channel, the system information message including parameters that identify the specified offset frequency.

17. The method according to claim 16, further comprising
sending additional system information messages on at least one broadcast channel centered on a secondary synchronization channel.

18. The method according to claim 12, wherein the primary synchronization symbol is located on a 200 kHz raster.

19. The method according to claim 12, wherein the plurality of secondary synchronization channels comprise an upper secondary synchronization channel located at a specified offset frequency above the center synchronization channel and a lower secondary synchronization channel located at a specified offset frequency below the center synchronization channel.

20. A wireless communication device comprising:
an antenna;
a transceiver coupled to the antenna;
a controller coupled to the transceiver, the controller configured to control operations of the wireless communication device;
a cell search module coupled to the controller, the cell search module configured to perform an initial cell search and acquire, during the initial cell search, a primary synchronization symbol only on a center synchronization channel of a plurality of synchronization channels, the plurality of synchronization channels including the center synchronization channel and a plurality of secondary synchronization channels;
a symbol association module configured to associate the primary synchronization symbol with the plurality of secondary synchronization channels; and
a frequency translation execution module configured to execute a frequency translation to change a receive channel to acquire one of the secondary synchronization channels.

21. The wireless communication device according to claim 20, wherein the transceiver comprises a local oscillator, and
wherein the frequency translation execution module is configured to execute the frequency translation by adjusting a local oscillator reference frequency to change a receive channel to acquire one of the secondary synchronization channels.

22. The wireless communication device according to claim 20, wherein the frequency translation execution module is configured to process information from a system information message on a broadcast channel centered on the center synchronization channel, the system information message including parameters that identify an amount of frequency translation.

23. The wireless communication device according to claim 22, wherein the transceiver is configured to receive additional system information messages on at least one broadcast channel centered on at least one of the plurality of secondary synchronization channels.

24. The wireless communication device according to claim 20, wherein the primary synchronization symbol is located on a 200 kHz raster.
